(19) United States
(12) Patent Application Publication
(10) Pub. No.: US 2023/0377230 A1
(43) Pub. Date: Nov. 23, 2023

(54) STYLE TRANSFER PROGRAM, STYLE TRANSFER DEVICE, AND STYLE TRANSFER METHOD

(71) Applicant: Square Enix Co., Ltd., Tokyo (JP)

(72) Inventors: Simon Francis STANNUS, Tokyo (JP); Edgar HANDY, Tokyo (JP); Isamu HASEGAWA, Tokyo (JP); Youichiro Miyake, Tokyo (JP)

(21) Appl. No.: 18/320,062

(22) Filed: May 18, 2023

(30) Foreign Application Priority Data
May 20, 2022 (JP) 2022-083446

(51) Int. Cl. G06T 11/60; G06T 7/11; G06T 7/50

(52) U.S. Cl. CPC G06T 11/60; G06T 7/11; G06T 7/50; G06T 2207/20084; G06T 2207/20021; G06T 2207/20221

(57) ABSTRACT

A highly expressive image is output based on an input image. A style transfer program causes a processor to implement a distance estimation function of estimating a distance to a target included in an image, a region defining function of demarcating one or more regions from the image based on the estimated distance, and a style transfer function of performing a style transfer to the regions in the image.

### CROSS-REFERENCE TO RELATED APPLICATION(S)

This application claims priority to and the benefit of Japanese Patent Application 2022-083446 filed May 20, 2022, the disclosure of which is incorporated herein by reference in its entirety for any purpose.

### TECHNICAL FIELD

At least one embodiment of the present disclosure relates to a style transfer program, a style transfer device, and a style transfer method.

### BACKGROUND

A style transfer technique is known for converting a photographic image into an image according to a predetermined style such as Van Gogh style or Monet style.

Examples of the style transfer technique may be found in Japanese Patent Application Publication 2020-187583A.

### SUMMARY

Style transfer in the related art converts the entire input image into a predetermined style such as Monet style. However, simply converting the entire input image into a predetermined style is considered to have a narrow range of expressiveness. Also, expressive and flexible style transfers, such as converting part of an input image to one style and another part to another style, were not possible.

Here, for example, if it is possible to selectively perform style transfer on a partial region of an image captured by a camera or the like, the expressiveness of the output image is further increased.

An object of at least one embodiment of the present disclosure is to solve the above problems and output a highly expressive image based on an input image.

According to an aspect without limitation, a style transfer program according to an embodiment of the present disclosure causes a processor to implement a distance estimation function of estimating a distance to a target included in an image, a region defining function of demarcating one or more regions from the image based on the estimated distance, and a style transfer function of performing a style transfer to the regions in the image.

According to an aspect without limitation, a style transfer device according to one embodiment of the present disclosure includes a processor and a memory, and the processor cooperates with the memory to implement a distance estimation function of estimating a distance to a target included in an image, a region defining function of demarcating one or more regions from the image based on the estimated distance, and a style transfer function of performing a style transfer to the regions in the image.

According to an aspect without limitation, a style transfer method according to an embodiment of the present disclosure is a style transfer method by a computer device equipped with a processor and a memory, and includes a distance estimation process of estimating a distance to a target included in an image, a region defining process of demarcating one or more regions from the image based on the estimated distance, and a style transfer process of performing a style transfer to the regions in the image.

Embodiments of the present disclosure address one or more problems.

### BRIEF DESCRIPTION OF THE DRAWINGS

FIG. 1 is a block diagram illustrating an example configuration of an image processing system according to at least one embodiment of the present disclosure.

FIG. 2 is a block diagram illustrating a configuration of a user terminal according to at least one embodiment of the present disclosure.

FIG. 3 is a flowchart illustrating a processing example of a style transfer program according to at least one embodiment of the present disclosure.

FIG. 4 is a conceptual diagram illustrating an example structure of a neural network used for general style transfer, according to at least one embodiment of the present disclosure.

FIG. 5 is a conceptual diagram illustrating an example structure of a neural network used for style transfer, according to at least one embodiment of the present disclosure.

FIG. 6 is a flowchart illustrating an example of an optimization process, according to at least one embodiment of the present disclosure.

FIG. 7 is a conceptual diagram illustrating an example structure of a neural network used for style transfer using masks, according to at least one embodiment of the present disclosure.

FIG. 8 is a conceptual diagram illustrating an example mask used for style transfer, according to at least one embodiment of the present disclosure.

FIG. 9 is a conceptual diagram illustrating a calculation method of parameters used in normalization performed in a processing layer, according to at least one embodiment of the present disclosure.

FIG. 10 is a conceptual diagram illustrating a calculation method of parameters used in normalization performed in the processing layer, according to at least one embodiment of the present disclosure.

FIG. 11 is a conceptual diagram illustrating normalization performed in the processing layer, according to at least one embodiment of the present disclosure.

FIG. 12 is a conceptual diagram illustrating an affine transformation process after normalization, according to at least one embodiment of the present disclosure.

FIG. 13 is a conceptual diagram illustrating a style transfer process using masks, according to at least one embodiment of the present disclosure.

FIG. 14 is a conceptual diagram illustrating a style transfer process using masks, according to at least one embodiment of the present disclosure.

FIG. 15 is a conceptual diagram illustrating masks when it is desired to divide image data into three regions and apply different styles to each region, according to at least one embodiment of the present disclosure.

FIG. 16 is a conceptual diagram illustrating normalization performed in the processing layer, according to at least one embodiment of the present disclosure.

FIG. 17 is a conceptual diagram illustrating an affine transformation process after normalization, according to at least one embodiment of the present disclosure.

FIG. 18 is a conceptual diagram illustrating an image before style transfer, according to at least one embodiment of the present disclosure.

FIG. 19 is a conceptual diagram illustrating a state in which an image after style transfer is output to a user terminal, according to at least one embodiment of the present disclosure.

FIG. 20 is a conceptual diagram illustrating an image before style transfer, according to at least one embodiment of the present disclosure.

FIG. 21 is a conceptual diagram illustrating a state in which an image after style transfer is output to a user terminal, according to at least one embodiment of the present disclosure.

FIG. 22 is a flowchart illustrating a processing example of a style transfer program according to at least one embodiment of the present disclosure.

### DETAILED DESCRIPTION

Hereinafter, examples of embodiments of the present disclosure will be described with reference to the drawings. The various constituent elements in the examples of the respective embodiments described below can be appropriately combined within a range that does not cause contradiction. Also, the content described as an example of a certain embodiment may be omitted in other embodiments. Further, the contents of operations and processes that are not related to the features of each embodiment may be omitted. Further, the order of various processes constituting various flows and sequences described below is random as long as there is no contradiction in the processing contents.

An outline of an embodiment of the present disclosure will be described. Hereinafter, as an embodiment, a style transfer program executed in a user terminal, which is an example of a computer included in an image processing system, will be described.

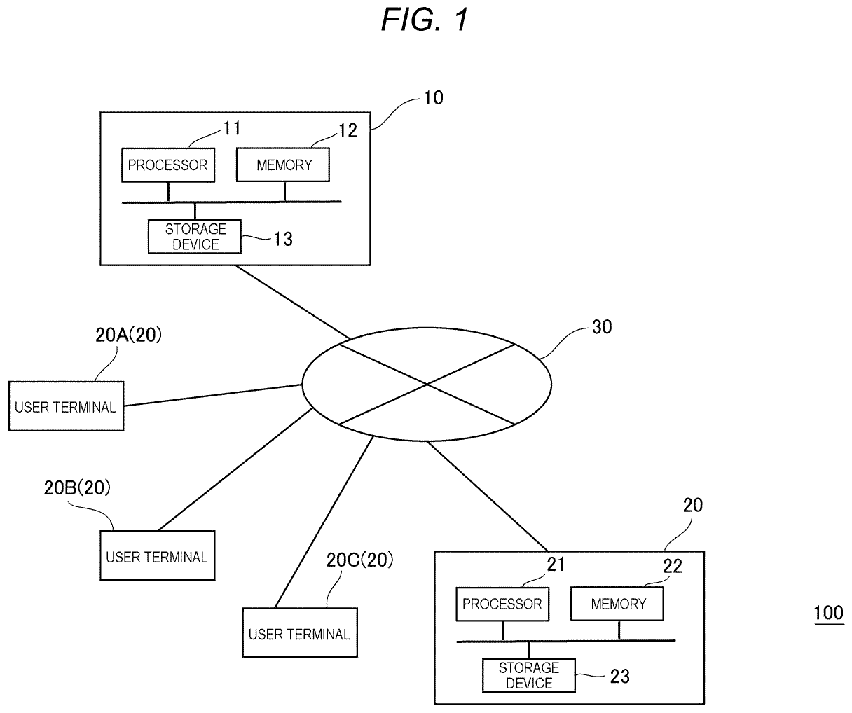

FIG. 1 is a block diagram illustrating an example of the configuration of an image processing system 100 according to at least one embodiment of the present disclosure. The image processing system 100 includes a video game processing server 10 (server 10) and a user terminal 20 used by a user (game player and the like) of the image processing system 100. User terminals 20A, 20B, and 20C are examples of the user terminal 20, respectively. The configuration of the image processing system 100 is not limited thereto. For example, the image processing system 100 may have a configuration in which a single user terminal is used by a plurality of users. The image processing system 100 may include a plurality of servers.

The server 10 and the user terminal 20 are examples of the computer. The server 10 and the user terminal 20 are communicably connected to a communication network 30 such as the Internet. The connection between the communication network 30 and the server 10 and the connection between the communication network 30 and the user terminal 20 may be wired or wireless. For example, the user terminal 20 may be connected to the communication network 30 by performing data communication with a base station managed by a communication carrier through a wireless communication line.

The image processing system 100 includes the server 10 and the user terminal 20, thereby implementing various functions for executing various processes in response to user operations.

The server 10 controls progress of the video game. The server 10 is managed by an administrator of the image processing system 100 and has various functions for providing information on various types of processing to a plurality of user terminals 20.

The server 10 includes a processor 11, a memory 12, and a storage device 13. The processor 11 is, for example, a central processing device such as a CPU (Central Processing Unit) that performs various calculations and controls. Also, if the server 10 is equipped with a GPU (Graphics Processing Unit), the GPU may perform some of the various calculations and controls. The server 10 uses the data read out to the memory 12 to execute various types of information processing in the processor 11, and stores the obtained processing results in the storage device 13 as necessary.

The storage device 13 has a function as a storage medium for storing various types of information. The configuration of the storage device 13 is not particularly limited, but from the viewpoint of reducing the processing load on the user terminal 20, it is preferable that the storage device 13 has a configuration capable of storing all the various types of information necessary for the control performed by the image processing system 100. Examples of such include HDDs and SSDs. However, the storage device for storing various types of information only needs to have a storage area that can be accessed by the server 10, and may be configured to have a dedicated storage area outside the server 10, for example.

The server 10 may be configured by an information processing device such as a game server capable of rendering game images.

The user terminal 20 is configured by a communication terminal managed by a user. The user terminal 20 may be configured by a communication terminal capable of playing a network-distributed game. Examples of communication terminals capable of playing network-distributed games include mobile phone terminals including smartphones, PDAs (Personal Digital Assistants), portable game devices, VR goggles, AR glasses, smart glasses, and so-called wearable devices. The configuration of the user terminal that can be included in the image processing system 100 is not limited to the above, and any configuration that allows the user to recognize the composite image may be used. Other examples of user terminal configurations include a combination of various communication terminals, a personal computer, and a stationary game device.

The user terminal 20 includes hardware that connects to the communication network 30 and communicates with the server 10 to perform various types of processing (for example, a display device for displaying a browser screen corresponding to coordinates or a game screen), and software. Each of the plurality of user terminals 20 may be configured to be able to directly communicate with each other without going through the server 10.

The user terminal 20 may have a built-in display device. Also, a display device may be connected to the user terminal 20 in a wireless or wired manner. The display device has an extremely general configuration, and is therefore not illustrated here. The game screen, for example, is displayed by the display device as the aforementioned composite image, and the user recognizes this composite image. The game screen is displayed, for example, on a display, which is an example of a display device provided in the user terminal, or a display, which is an example of a display device connected to the user terminal. The display device includes, for example, a hologram display device capable of displaying a hologram, and a projection device for projecting an image (including a game screen) on a screen or the like.

The user terminal 20 includes a processor 21, a memory 22, and a storage device 23. The processor 21 is, for example, a central processing device such as a CPU (Central Processing Unit) that performs various calculations and controls. Also, if the user terminal 20 is equipped with a GPU (Graphics Processing Unit), the GPU may perform some of the various calculations and controls. The user terminal 20 uses the data read out to the memory 22 to execute various types of information processing in the processor 21, and stores the obtained processing results in the storage device 23, as necessary. The storage device 23 has a function as a storage medium for storing various information.

The user terminal 20 may incorporate an input device. Also, an input device may be connected to the user terminal 20 in a wireless or wired manner. The input device receives an operation input by a user. A processor provided in the server 10 or a processor provided in the user terminal 20 executes various control processes in response to an operation input by the user. Examples of the input device include a touch panel screen of a mobile phone terminal and a controller wirelessly or wiredly connected to AR glasses. In addition, the camera provided in the user terminal 20 can also correspond to the input device. The user performs operation input by gestures such as moving a hand in front of the camera (gesture input).

The user terminal 20 may further include a GPS unit, compass, inertial measurement unit (IMU), camera, and the like. The inertial measurement unit may include an accelerometer, a gyroscope, and the like. The compass and inertial measurement unit may be implemented by a program capable of providing the orientation of the user terminal 20.

In addition, the user terminal 20 may include other output devices such as speakers. Other output devices output audio and various other information to the user.

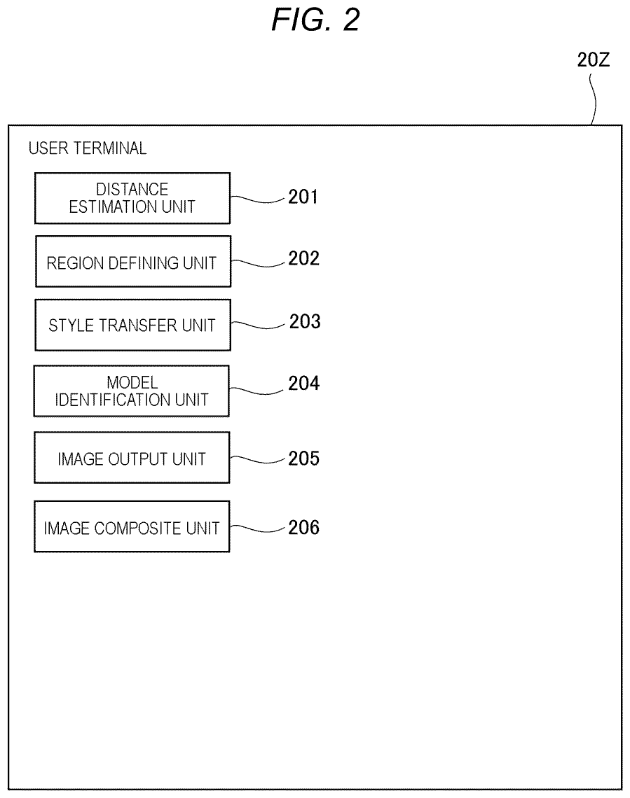

FIG. 2 is a block diagram illustrating a configuration of a user terminal according to at least one embodiment of the present disclosure. A user terminal 20Z, which is an example of the user terminal 20, includes a distance estimation unit 201, a region defining unit 202, and a style transfer unit 203. The user terminal 20Z may further include a model identification unit 204, an image output unit 205, and an image composite unit 206. The processor provided in the user terminal 20Z refers to the style transfer program stored in the storage device and executes the program to functionally implement the distance estimation unit 201, the region defining unit 202, the style transfer unit 203, and the model identification unit 204, the image output unit 205, and the image composite unit 206.

The distance estimation unit 201 has a function of estimating the distance to a target included in an image. The region defining unit 202 has a function of demarcating one or more regions from the image based on the estimated distance. The style transfer unit 203 has a function of performing a style transfer on the region in the image. The model identification unit 204 has a function of identifying a model corresponding to the target. The image output unit 205 has a function of outputting the image. The image output by the image output unit 205 may be a still image or a moving image. The image output unit 205 may output an image including an AR object. An AR object is a virtual object superimposed on an image. The image composite unit 206 has a function of blending images.

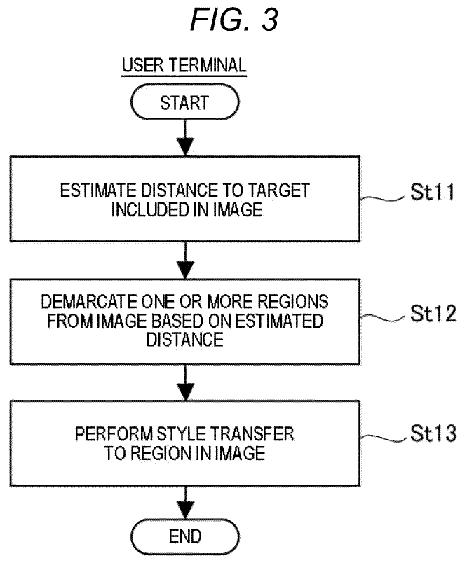

Next, program execution processing according to the embodiment of the present disclosure will be described. FIG. 3 is a flowchart illustrating a processing example of a style transfer program according to at least one embodiment of the present disclosure.

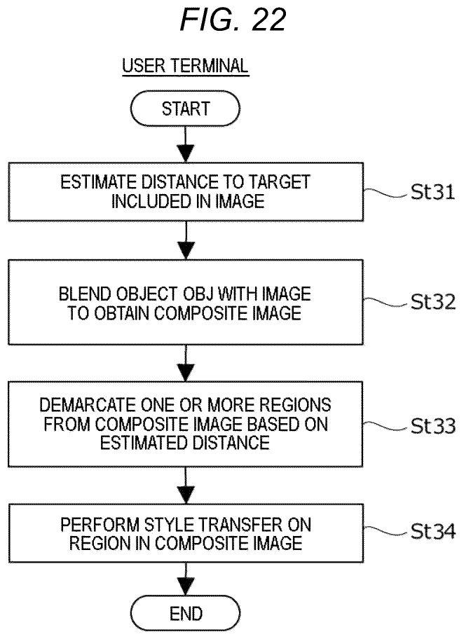

The distance estimation unit 201 estimates the distance to a target included in an image (St11). The region defining unit 202 demarcates one or more regions from the image based on the estimated distance (St12). The style transfer unit 203 performs a style transfer on the region in the image (St13). The image referred to here includes a composite image, which will be described later with reference to FIG. 22.

### [Distance Estimation]

The image in step St11 means, for example, an image captured by the user terminal 20 having an imaging device such as a camera. The image may be a still image or a moving image. The image may be an image other than the image captured by the user terminal 20. The image may be, for example, an image stored in the memory 22 or the storage device 23, an image received from an external device such as the server 10 via the communication network 30, or the like.

A target included in an image means something that can be segmented into regions, such as an object. For example, a window is an object and it is possible to divide the regions into the window and the region other than the window. As such, a window can be a target included in an image. Similarly, buildings, cars, people, animals, and the like can also be targets included in the image. Tangible objects other than those listed may also be a target included in the image.

The target included in an image may be an object other than a tangible object. For example, when the sky and buildings are reflected in the captured image, the region can be divided into regions of sky and buildings, so the sky can be a target included in the image.

The distance to the target means the distance from the viewpoint from which the image is captured to the target. For example, when an image is captured by a camera, the camera is the viewpoint. Therefore, in this case, the distance to the target means the distance from the camera to the target.

For distance estimation, the model identification unit 204 described above may be used. The model identification unit 204 identifies a model corresponding to the target. The model may be a 3D model. The model is stored in advance in the memory 22, the storage device 23, or a storage device provided in an external device. The model identification unit 204 performs collation between the target included in the image and a plurality of stored models, and identifies the model corresponding to the target. For the collation, for example, pattern collation disclosed in JP2021-114286A may be used. Then, the distance estimation unit 201 estimates the distance to the target based on the identified model.

The distance estimation unit 201 may perform distance estimation using other algorithms such as photogrammetry.

### [Region Definition]

The region defining unit 202 demarcates one or more regions from the image based on the estimated distance. For example, the region defining unit 202 demarcates a portion of the image that is closer than the target by a predetermined distance or more as a region. The region defining unit 202 demarcates a portion of the image that is farther than the target by a predetermined distance or more as a region. The region defining unit 202 may demarcate a region including the target.

For example, if the target is a tower that is reflected in the captured image, the region defining unit 202 may demarcate a portion closer than the tower among the portions reflected in the image as a region. Similarly, the region defining unit 202 may demarcate a portion farther than the tower among the portions reflected in the image as a region. Also, the demarcated region may include a tower.

### [Style Transfer]

The style transfer unit 203 has a function of performing a style transfer on the region in the image. The region where the style transfer is performed is typically the region demarcated by the region defining unit 202, but it may be a region other than the region demarcated by the region defining unit 202. For example, a case where a building is reflected in the image is assumed. The region defining unit 202 demarcates the portion of the building reflected in the image as a region. The region to which the style transfer is applied may be the portion of the building in the image. On the other hand, the region to which the style transfer is applied may be the region of the image excluding the building portion.

A mask style transfer technique, which will be described later, can be used when style transfer is performed to a region.

A style in style transfer means a style or model in architecture, art, music, and the like. The style may mean, for example, a style of painting such as Van Gogh style or Picasso style. The style may refer to the format of the image (for example, color, predetermined texture, pattern, or the like). A style image means an image (still image or moving image) having a specific style.

The style transfer unit 203 may use a neural network for style transfer. Examples of a related technique include Vincent Dumoulin, et. al. “A LEARNED REPRESENTATION FOR ARTISTIC STYLE”, and the like. An output image to which style transfer has been applied is obtained by inputting an input image of a predetermined size to the neural network by the style transfer unit 203.

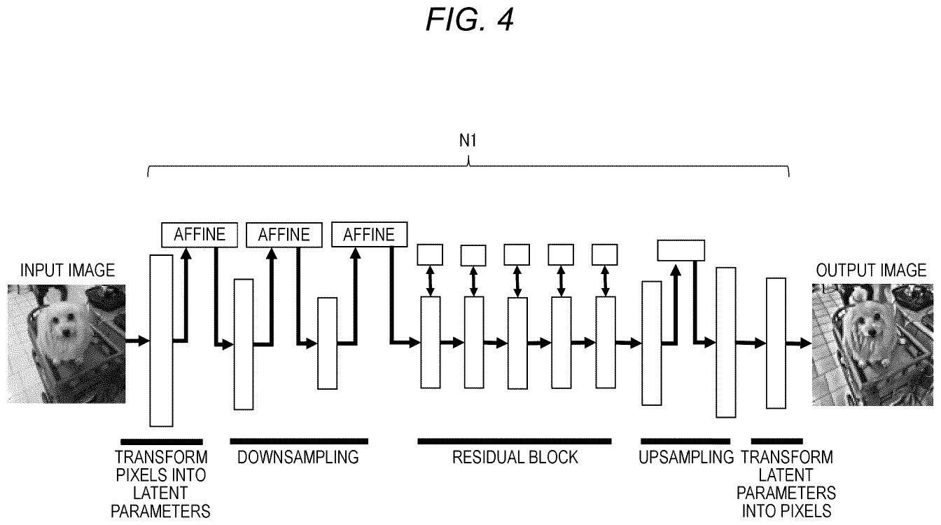

FIG. 4 is a conceptual diagram illustrating an example structure of a neural network N1 used for general style transfer, according to at least one embodiment of the present disclosure. The neural network N1 includes a first transformation layer that transforms a group of pixels based on the input image into latent parameters, one or more layers that perform downsampling by convolution or the like, a plurality of residual block layers, a layer that performs upsampling, and a second transformation layer that transforms the latent parameters into a group of pixels. An output image is obtained based on the group of pixels that are the output of the second transformation layer.

The normalization process and the affine transformation process are performed on each channel of feature maps, between the first transformation layer of the neural network N1 and the downsampling layer, between the plurality of convolution layers included in the downsampling layer, and the like. FIG. 4 illustrates the affine transformation process out of the normalization process and the affine transformation process.

The style transfer unit 203 inputs the image data to the first transformation layer of the neural network N1, so that the data after applying the style transfer is output from the second transformation layer of the neural network N1.

### [Style Transfer Blending Plurality of Style Images]

The style transfer unit 203 may perform style transfer by blending a plurality of styles to the same portion of the input image. In this case, the style transfer unit 203 mixes parameters based on a plurality of style images in a predetermined layer of the neural network, and inputs input image data to the trained neural network obtained by performing an optimization process based on an optimization function. The optimization function is preferably defined based on the plurality of style images.

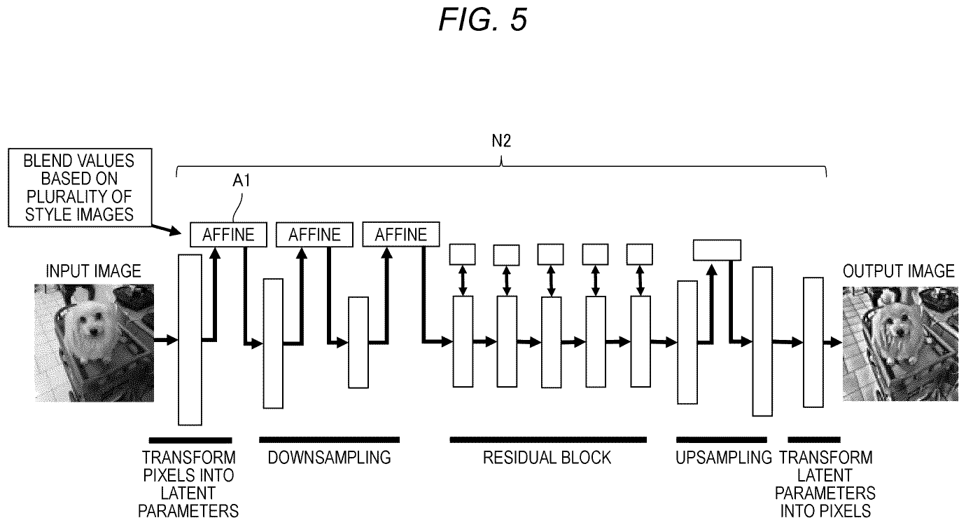

FIG. 5 is a conceptual diagram illustrating an example structure of a neural network N2 used for style transfer, according to at least one embodiment of the present disclosure. The neural network N2 includes a first transformation layer that transforms a group of pixels into latent parameters based on the input image, one or more layers that perform downsampling by convolution or the like, a plurality of residual block layers, a layer that performs upsampling, and a second transformation layer that transforms the latent parameters into a group of pixels. An output image is obtained based on the group of pixels that are the output of the second transformation layer.

The normalization process and the affine transformation process are performed on each channel of feature maps, between the first transformation layer of the neural network N2 and the downsampling layer, between the plurality of convolution layers included in the downsampling layer, and the like. FIG. 5 illustrates the affine transformation process out of the normalization process and the affine transformation process.

An affine layer A1 of the neural network N2 is mixed with parameters based on a plurality of style images. More specifically, it is as follows.

The affine layer A1 of the neural network N2 is a layer that performs a process for transforming the latent variable x of the output of the convolutional layer to x*a+b, where a and b are the parameters of the affine transformation and x is the latent variable of the pixel of the image.

Here, when any styles 1 and 2 are blended, the processing performed in the affine layer A1 under the control of the style transfer unit 203 is as follows. It is assumed that a1 and b1 are the affine transformation parameters derived from the style image associated with style 1. It is assumed that a2 and b2 are the affine transformation parameters derived from the style image associated with style 2. At this time, the affine transformation parameters for blending style 1 and style 2 are a=(a1+a2)/2 and b=(b1+b2)/2. Then, by calculating x*a+b in the affine layer A1, a blend of styles 1 and 2 can be performed. The above shows a calculation formula for blending styles 1 and 2 evenly (50% each). Based on the common knowledge of those skilled in the art, blending may be weighted so that the influence based on each style has a different proportion, such as 80% for style 1 and 20% for style 2.

The number of styles to blend may be three or more. When n is a natural number of 3 or more, affine transformation parameters for blending n styles are, for example, a=(a1+a2 . . . +an)/n and b=(b1+b2 . . . +bn)/n. It is assumed that ak and bk are the affine transformation parameters derived from the style image associated with style k, where k is any natural number between 1 and n. As in the case where the number of styles is two, the styles may be weighted so that the degree of influence based on each style has a different ratio and then blended.

The memory 22 or the like of the user terminal 20Z may store transfer parameters ak and bk for a plurality of styles. Also, transfer parameters for a plurality of styles are stored in the memory 22, the storage device 23, and the like in vector format, such as (a1, a2, . . . , an) and (b1, b2, . . . , bn). When weighting is performed so that the degree of influence based on each style has a different ratio, a value indicating the weight according to each style may be stored in the memory 22, the storage device 23, or the like.

Next, an optimization function for performing machine learning on the neural network N2 will be described. An optimization function is sometimes called a loss function. A trained neural network N2 is obtained by performing an optimization process on the neural network N2 based on an optimization function defined based on a plurality of style images. For convenience of description, the same reference numeral N2 is used for each neural network before and after training.

For example, in the related art mentioned above, an optimization function defined as follows is used.

Style Optimization Function:

$${s}_{} ( p ) = {\sum }_{i ∈ S} \frac{1}{{U}_{i}} {\vert \vert G ( {ϕ}_{i} ( p ) ) - G ( {ϕ}_{i} ( s ) ) \vert \vert}_{F}^{2} \qquad [ Formula 1 ]$$

Content Optimization Function:

$${c}_{} ( p ) = {\sum }_{j ∈ C} \frac{1}{{U}_{j}} {\vert \vert {ϕ}_{j} ( p ) - {ϕ}_{j} ( c ) \vert \vert}_{2}^{2} \qquad [ Formula 2 ]$$

In the above optimization function, p indicates the generated image. The generated image corresponds to the output image of the neural network used for machine learning. s (lowercase s) indicates a style image such as an abstract painting. Ui denotes the total number of units in the layer i. Uj indicates the total number of units in the layer j. G indicates a Gram matrix. φi indicates the output of the i-th activation function of the VGG-16 architecture. S (uppercase S) indicates the layer group of VGG-16 for computing style optimizations. c (lowercase c) indicates a content image. C (uppercase C) is the layer group of VGG-16 for computing the content optimization function, and j is the index of the layer contained in the layer group. The F appended to the absolute value sign means the Frobenius norm.

By performing machine learning on the neural network so as to minimize the value of the optimization function defined by the style optimization function and content optimization function described above, and inputting an input image to the trained neural network, an output image that has been transformed so as to approximate the style indicated by the style image is output from the neural network.

Here, in the optimization process using the optimization function as described above, there is room for further improvement in the result of blending when performing style transfer by blending a plurality of styles.

Therefore, the user terminal 20Z performs an optimization process based on an optimization function defined based on a plurality of style images. This allows optimization based on a plurality of style images. As a result, it is possible to obtain an output image in which a plurality of styles is nicely blended with the input image.

More specifically, the optimization process may include a first optimization process that performs the optimization process using a first optimization function defined based on any two style images selected from a plurality of style images, and a second optimization process that performs the optimization process using a second optimization function defined based on one style image among the plurality of style images. As a result, suitable optimization can be performed when the number of styles to be blended is three or more. As a result, it is possible to obtain an output image in which a plurality of styles is further nicely blended with the input image.

Next, the first optimization function and the second optimization function will be described. In one aspect of an embodiment, the first optimization function may be defined by Expression (1) below.

$${q , r}_{} ( p ) = {\sum }_{i ∈ S} {\vert \vert \frac{G ( {ϕ}_{i} ( p ) )}{{N}_{i , r} * {N}_{i , c}} - \frac{1}{2} [ \frac{G ( {ϕ}_{i} ( q ) )}{{N}_{i , r} * {N}_{i , c}} + \frac{G ( ( {ϕ}_{i} ( r ) )}{{N}_{i , r} * {N}_{i , c}} ] \vert \vert}_{F}^{2} ; \qquad ( 1 )$$

$$q \neq r ∀ q ∀ r , q ∈ \hat{S} , r ∈ \hat{S}$$

In one aspect of the embodiment, the second optimization function may be defined by Expression (2) below.

$${s}_{} ( p ) = {\sum }_{i ∈ S} {\vert \vert \frac{G ( {ϕ}_{i} ( p ) )}{{N}_{i , r} * {N}_{i , c}} - \frac{G ( {ϕ}_{i} ( s ) )}{{N}_{i , r} * {N}_{i , c}} \vert \vert}_{F}^{2} \qquad ( 2 )$$

In the above expression,

Ŝ [Formula 5]

is a style image group consisting of a plurality of style images, and q and r indicate any style images included in the style image group. However, q and r are style images different from each other. Ni,r is the number of rows in the φi feature map. Ni,c is the number of columns in the φi feature map. p, s (lowercase s), G, φi, S, c (lowercase c), and F are the same as in the related art described above.

The above first optimization function is a function that sums the norm between the value obtained by performing a predetermined computation on the image p and the average value of the values obtained by performing the above-mentioned predetermined computation on the style images q and r, where p is the generated image, and q and r are any two style images selected from the plurality of style images. The above expression (1) shows the case where the predetermined computation is:

$$\frac{G ∘ {ϕ}_{i}}{{N}_{i , r} * {N}_{i , c}} \qquad [ Formula 6 ]$$

The predetermined computation may be computation other than the above.

The above second optimization function is a function that sums the norm between the value obtained by performing a predetermined computation on the image p and the value obtained by performing the predetermined computation on the style image s, where p is the generated image and s is the style image. The above expression (2) shows the case where the predetermined computation is:

$$\frac{G ∘ {ϕ}_{i}}{{N}_{i , r} * {N}_{i , c}} \qquad [ Formula 7 ]$$

The predetermined computation may be computation other than the above.

Next, an example of the optimization process using the above-described first optimization function and second optimization function will be described.

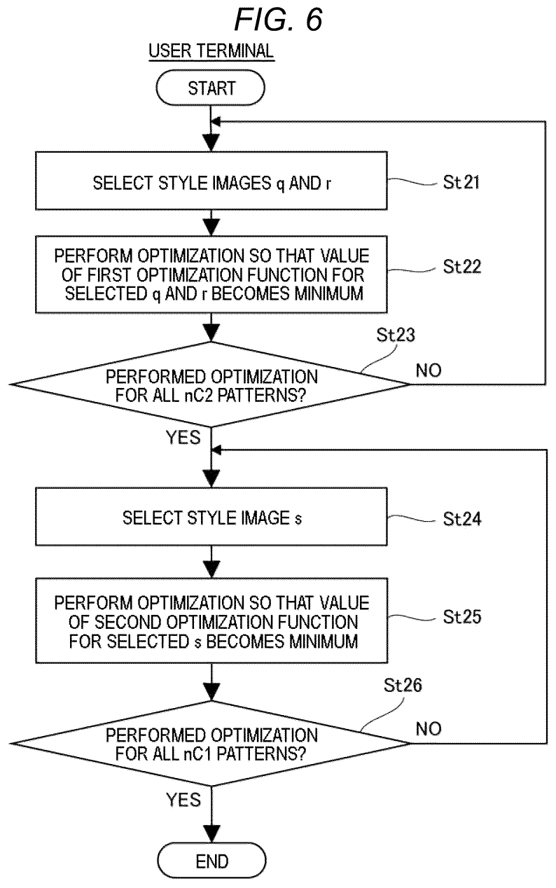

FIG. 6 is a flowchart showing an example of the optimization process corresponding to at least one embodiment of the present disclosure. Here, a process example in which the first optimization function is the function defined by the above expression (1) and the second optimization function is the function defined by the above expression (2) will be described.

The subject of optimization process is the processor provided in the device. A device with a processor (hereafter, device A) may be the user terminal 20Z described above. In this case, the processor 21 illustrated in FIG. 1 is the processing entity. The device A provided with the processor may be a device other than the user terminal 20Z (for example, the server 10 or the like).

It is assumed that n is the number of styles to be blended. The processor selects any two style images q and r among n style images included in the style image group (St21).

The processor performs optimization to minimize the value of the first optimization function for the selected style images q and r (St22). For the generated image p, the processor acquires the output image of the neural network as the image p. The neural network may be implemented in the device A, or may be implemented in a device other than the device A.

The processor determines whether or not optimization has been performed for all nC2 patterns (St23). That is, the processor determines whether or not all patterns for selecting any two style images q and r among n style images have been processed. If optimization has been performed on all nC2 patterns (St23: YES), the process proceeds to step St24. If optimization has not been performed on all nC2 patterns (St23: NO), the process returns to step St21, and the processor selects the next combination of two style images q and r.

The processor selects one style image s among n style images included in the style image group (St24).

The processor performs optimization to minimize the value of the second optimization function for the selected style image s (St25). For the generated image p, the processor acquires the output image of the neural network as the image p. The neural network may be implemented in the device A, or may be implemented in a device other than the device A.

The processor determines whether or not optimization has been performed for all nC1 patterns (St26). That is, the processor determines whether or not all patterns for selecting any style image s from n style images have been processed. If optimization has been performed on all nC1 patterns (St26: YES), the optimization process illustrated in FIG. 6 ends. If optimization has not been performed on all nC1 patterns (St26: NO), the process returns to step St24, and the processor selects the next one style image s.

The style transfer unit 203 inputs the image data to the first transformation layer of the trained neural network N2 optimized as described above, for example. As a result, style transfer-applied data in which the n style images are nicely blended is output from the second transformation layer of the neural network N2.

For example, as described above, the style transfer unit 203 can apply style transfer to image data based on a single style or a plurality of styles.

### [Mask Style Transfer]

Next, style transfer using a mask (mask style transfer) will be described. Mask transfer according to embodiments of the present disclosure can perform style transfer on one or more regions included in an image without dividing the image. For example, if an image includes two regions A and B, it can be said that only the region A undergoes style transfer and the region B does not undergo style transfer. This is the same in the case where the image includes three or more regions, and one or more regions can be selected and the style transfer can be performed only on the selected regions. Furthermore, processing such as dividing the original image into regions is not required during these style transfers. A mask in the mask style transfer according to the embodiment of the present disclosure means data used for preventing style transfer for a partial region of the image data. For example, the image data is assumed to be image data (256×256×3) of 256 pixels vertically by 256 pixels horizontally having three color channels of RGB. The mask for this image data may be, for example, data of 256 pixels vertically and 256 pixels horizontally, and data (256×256×1) in which a numerical value between 0 and 1 is assigned to each pixel. The mask may be such that the closer the value of a pixel is to 0, the more strongly style transfer is prevented in the corresponding pixel of the image data. However, the mask may have a format different from that described above. For example, the mask may be such that the closer the value of a pixel is to 1, the more strongly style transfer is prevented in the corresponding pixel of the image data. Also, the maximum pixel value of the mask may be a value greater than one. The minimum pixel value of the mask may be less than zero. The mask may have pixels with only 0 or 1 values (hard mask).

The style transfer unit 203 generates a mask corresponding to the shape of the region to which the style transfer is applied. Next, the style transfer unit 203 inputs the image data and the mask to the neural network for style transfer. This allows the masks to be used to apply style transfers based on one or more style images to the image data.

The style transfer unit 203 may generate a plurality of masks for preventing style transfer for a partial region of the image data. For example, the style transfer unit 203 may generate a total of two masks including a mask that prevents style transfer for regions other than the region corresponding to a first building reflected in the image, and a mask that prevents style transfer for regions other than the region corresponding to a second building reflected in the image. A plurality of masks generated in this case have different regions for preventing style transfer. Then, the style transfer unit 203 applies style transfer based on a plurality of styles composed of a plurality of style images to the image data using a plurality of masks with different style transfer prevention regions.

The style transfer unit 203 may input the image data and a plurality of generated masks to the neural network for style transfer. This allows a plurality of masks to be used to apply style transfers based on a plurality of style images to the image data.

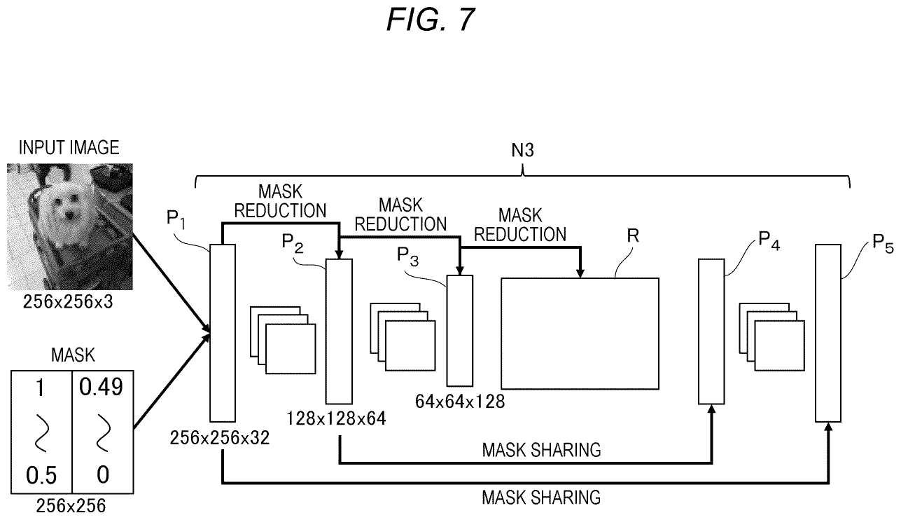

FIG. 7 is a conceptual diagram illustrating an example structure of a neural network N3 used for style transfer using masks, according to at least one embodiment of the present disclosure.

The neural network N3 includes a plurality of processing layers P1 to P5. The neural network N3 also has a residual block R.

The processing layer P1 corresponds to the first transformation layer in FIGS. 4 and 5. The processing layer P2 and the processing layer P3 correspond to one or more layers for downsampling in FIGS. 4 and 5. The residual block R corresponds to the residual block layer of FIGS. 4 and 5. The processing layer P4 and the processing layer P5 correspond to the layers for upsampling in FIGS. 4 and 5. The neural network N3 of FIG. 7 may further have a second transformation layer as illustrated in FIGS. 4 and 5.

The processing layer P1 has a size of 256×256×32. The processing layer P2 has a size of 128×128×64. The processing layer P3 has a size of 64×64×128. The processing layer P4 has a size of 128×128×64. The processing layer P5 has a size of 256×256×32. The number of processing layers and the size of the processing layers are only examples.

The style transfer unit 203 inputs the input image and a mask to the processing layer P1. The processing layers P1 to P5 each include a convolution process and a normalization process. As for the type of normalization process, Conditional Instance Normalization is used in the general style transfer illustrated in FIG. 4, for example. Masked Conditional Instance Normalization is used in mask style transfer. Masked Conditional Instance Normalization includes Masked Normalization described later and Masked Affine Transform described later.

Basically, feature amount data is extracted after processing by each processing layer. The extracted feature amount data is input to the next processing layer. That is, the feature amount data extracted from the processing layer P1 is input to the processing layer P2. The feature amount data extracted from the processing layer P2 is input to the processing layer P3. The feature amount data extracted from the processing layer P4 is input to the processing layer P5. As for the processing layer P3, the processing result by the processing layer P3 is input to the residual block R. The output of the residual block R is input to the processing layer P4.

A mask is input to the respective processing layers P1 to P5. Since the size of the processing layer varies from processing layer to processing layer, the size of the mask is also adapted according to the processing layer. For example, a mask obtained by reducing the mask input to the processing layer P1 is input to the processing layer P2. A mask obtained by reducing the mask input to the processing layer P2 is input to the processing layer P3. The reduction of the mask may be, for example, a reduction based on the Bilinear method.

In the present embodiment, since the size of the processing layer P1 and the size of the processing layer P5 are the same, the mask input to the processing layer P1 is input to the processing layer P5. Similarly, since the size of the processing layer P2 and the size of the processing layer P4 are the same, the mask input to the processing layer P2 is input to the processing layer P4.

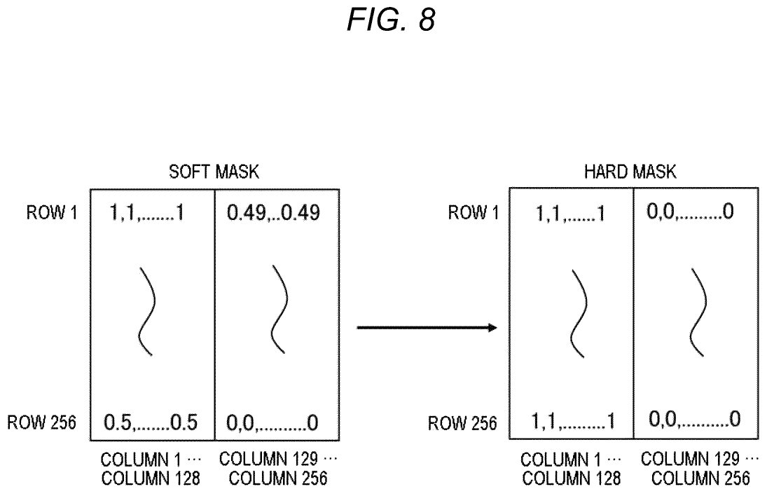

FIG. 8 is a conceptual diagram illustrating an example mask used for style transfer, according to at least one embodiment of the present disclosure.

For example, the mask input to the processing layer P1 has a size of 256 vertical×256 horizontal, which is the same as the 256 vertical×256 horizontal size of the input image. Masks include soft masks and hard masks. In the present embodiment, it is assumed that a soft mask is input to the processing layer P1. Further, a case where the style transfer unit 203 performs style transfer on the left half of the input image to style A and on the right half of the input image to style B will be described below as an example. Style A is a style corresponding to one or more style images. That is, style A may correspond to one style image (such as Van Gogh style), or may correspond to a plurality of style images (such as a blend of a Van Gogh style image and a Monet style image). Style B may correspond to one style image (such as Gauguin style), or may correspond to a plurality of style images (such as a blend of a Gauguin style image and a Picasso style image). The method of dividing the input image into left and right halves and performing the style transfer is merely an example. Depending on how the values of the mask are set, for example, style transfer can be done flexibly, such as style transfer performed by dividing the input image into two parts of upper and lower parts, style transfer performed by dividing the input image into three or more parts, or style transfer in which a plurality of styles are mixed in a certain region of the input image.

When the style transfer unit 203 performs style transfer on the left half of the input image to Style A and on the right half of the input image to style B, the style transfer unit 203 inputs a soft mask with different values for the left and right halves to the processing layer P1.

In the example illustrated in FIG. 8, in Columns 1 to 128, which are the left half of the soft mask, the values in Row 1 are 1 and the values in Row 256 are 0.5. Rows 2 to 255 of Columns 1 to 128 have numerical values that gradually decrease from 1 to 0.5.

In the example illustrated in FIG. 8, in Columns 129 to 256, which are the right half of the soft mask, the values in Row 1 are 0.49 and the values in Row 256 are 0. Rows 2 to 255 of Columns 129 to 256 have numerical values that gradually decrease from 0.49 to 0.

Next, the hard mask will be described. A hard mask is a mask in which the numerical values of each row and each column are 0 or 1. For example, a hard mask can be considered in which all the values are 1 in Columns 1 to 128, which are the left half of the hard mask, and all the values are 0 in Columns 129 to 256, which are the right half of the hard mask. This hard mask can be generated by rounding off the numerical values of each row and each column in the soft mask described above.

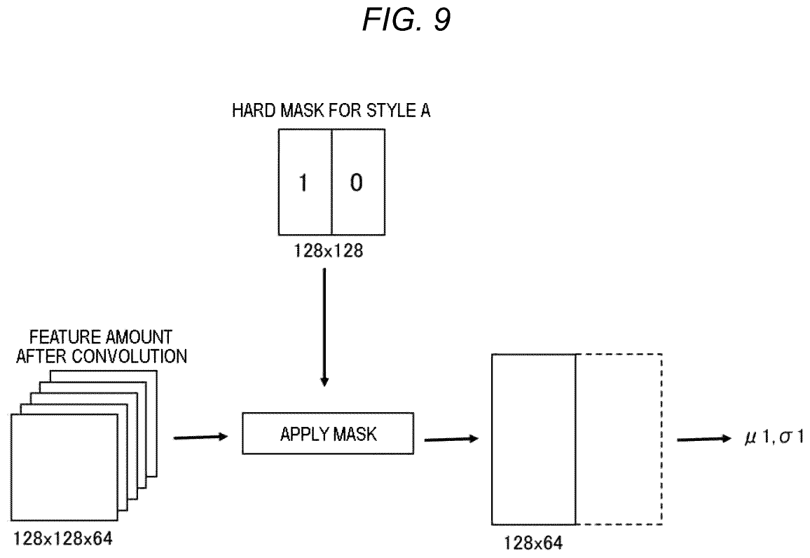

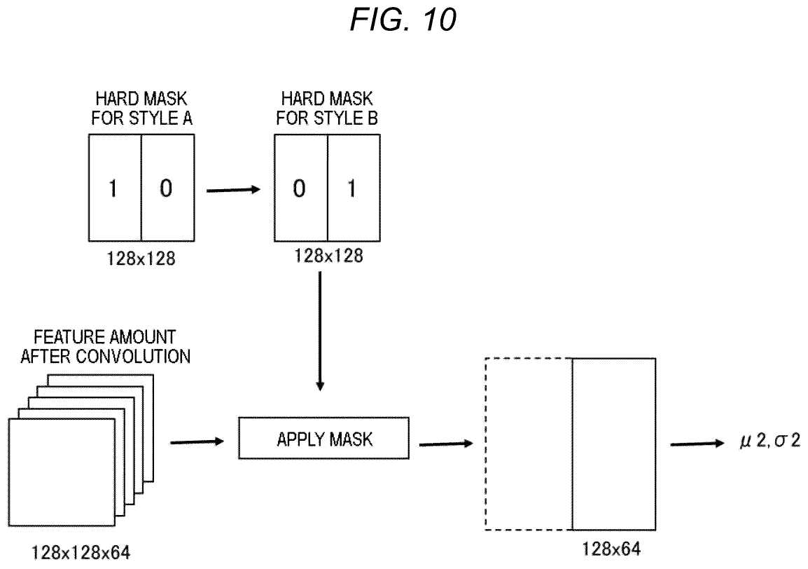

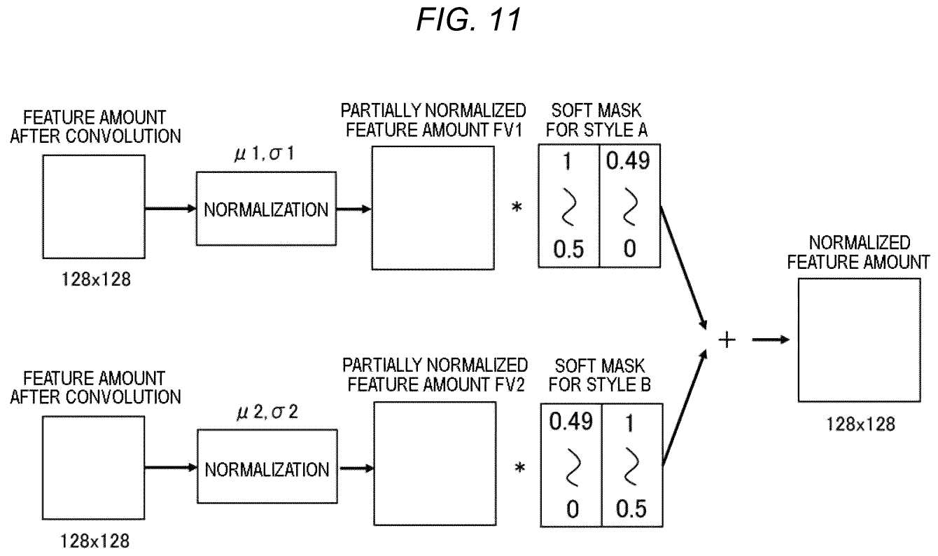

FIG. 9 is a conceptual diagram illustrating a calculation method of parameters used in normalization performed in the processing layer, according to at least one embodiment of the present disclosure. FIG. 10 is a conceptual diagram illustrating a calculation method of parameters used in normalization performed in the processing layer, according to at least one embodiment of the present disclosure. FIG. 11 is a conceptual diagram illustrating normalization performed in the processing layer, according to at least one embodiment of the present disclosure. An example of normalization performed in the processing layer will be described with reference to FIGS. 9 to 11. The normalization process illustrated in FIG. 11 corresponds to the Masked Normalization described above.

The size of feature amount data to be extracted differs for each processing layer (see FIG. 7). Also, the size of the feature amount data may change depending on the input image. Here, normalization will be described by exemplifying a feature amount having a size of 128×128×64 after convolution.

The hard mask corresponding to style A applied to the left half of the input image (style A hard mask) is a hard mask of 128 vertical×128 horizontal in which all values in the left half are 1 and all values in the right half are 0, as illustrated in FIG. 9. The style A hard mask can be generated by rounding off the numerical values in each row and each column of the soft mask illustrated in FIGS. 7 and 8 (sometimes referred to as a soft mask for style A).

The style transfer unit 203 applies the style A hard mask described above to the 128 vertical×128 horizontal feature amount data after convolution. The mask application method may be, for example, Boolean masking. However, it is not intended to exclude mask application algorithms other than Boolean masking.

When the style transfer unit 203 applies the style A hard mask to the feature amount data (128×128) using a Boolean mask, data of 128 vertical×64 horizontal is obtained. In other words, of the original feature amounts, only the portion corresponding to the portion (left half) where the value in the style A hard mask is 1 remains. The style transfer unit 203 calculates an average μ1 and a standard deviation σ1 of the feature amount data after applying the mask.

Next, the hard mask corresponding to style B applied to the right half of the input image (style B hard mask) is a hard mask of 128 vertical×128 horizontal in which all values in the left half are 0 and all values in the right half are 1, as illustrated in FIG. 10. The style B hard mask can be generated by inverting the left and right half values in the style A hard mask described above. The style B hard mask can be generated by inverting the left half value and the right half value of the soft mask (style A soft mask) illustrated in FIGS. 7 and 8, and then by rounding off the numerical values in each row and each column in the style B soft mask. Here, the style A soft mask and the style B soft mask correspond to a plurality of masks having different regions for preventing style transfer. Further, the style A hard mask and the style B hard mask correspond to a plurality of masks having different regions for preventing style transfer.

The style transfer unit 203 applies the style B hard mask described above to the 128 vertical×128 horizontal feature amount data after convolution. The mask application method may be, for example, Boolean masking. However, it is not intended to exclude mask application algorithms other than Boolean masking.

When the style transfer unit 203 applies the style B hard mask to the feature amount data (128×128) using a Boolean mask, data of 128 vertical×64 horizontal is obtained. In other words, of the original feature amounts, only the portion corresponding to the portion (right half) where the value in the style B hard mask is 1 remains. The style transfer unit 203 calculates an average μ2 and a standard deviation σ2 of the feature amount data after applying the mask.

Next, the description will be made with reference to FIG. 11. The style transfer unit 203 normalizes the feature amount data after convolution using the average μ1 and the standard deviation σ1. As a result, a partially normalized feature amount FV1 is obtained. The style transfer unit 203 applies the style A soft mask to the partially normalized feature amount FV1. A feature amount obtained by applying this soft mask is assumed to be a feature amount FV1A. The algorithm for applying the style A soft mask to the feature amount FV1 may be, for example, multiplication of values in the same row and the same column. In a specific example, the result of multiplying the value in Row 2 and Column 2 of the feature amount FV1 by the value in Row 2 and Column 2 of the style A soft mask becomes the value in Row 2 and Column 2 of the feature amount FV1A.

The style transfer unit 203 normalizes the convoluted feature amount data using the average μ2 and the standard deviation σ2. As a result, a partially normalized feature amount FV2 is obtained. The style transfer unit 203 applies the style B soft mask to the partially normalized feature amount FV2. A feature amount obtained by applying this soft mask is assumed to be a feature amount FV2B. The algorithm for applying the style B soft mask to the feature amount FV2 may be, for example, multiplication of values in the same row and the same column. In a specific example, the result of multiplying the value in Row 2 and Column 2 of the feature amount FV2 by the value in Row 2 and Column 2 of the style B soft mask becomes the value in Row 2 and Column 2 of the feature amount FV2B.

The style transfer unit 203 adds the feature amount FV1A and the feature amount FV2B. As a result, a normalized feature amount of 128 vertical×128 horizontal is obtained. The addition of the feature amount FV1A and the feature amount FV2B may be, for example, the addition of the values in the same row and the same column. In a specific example, the result of adding the value in Row 2 and Column 2 of the feature amount FV1A by the value in Row 2 and Column 2 of the feature amount FV2B becomes the value in Row 2 and Column 2 of the normalized feature amount.

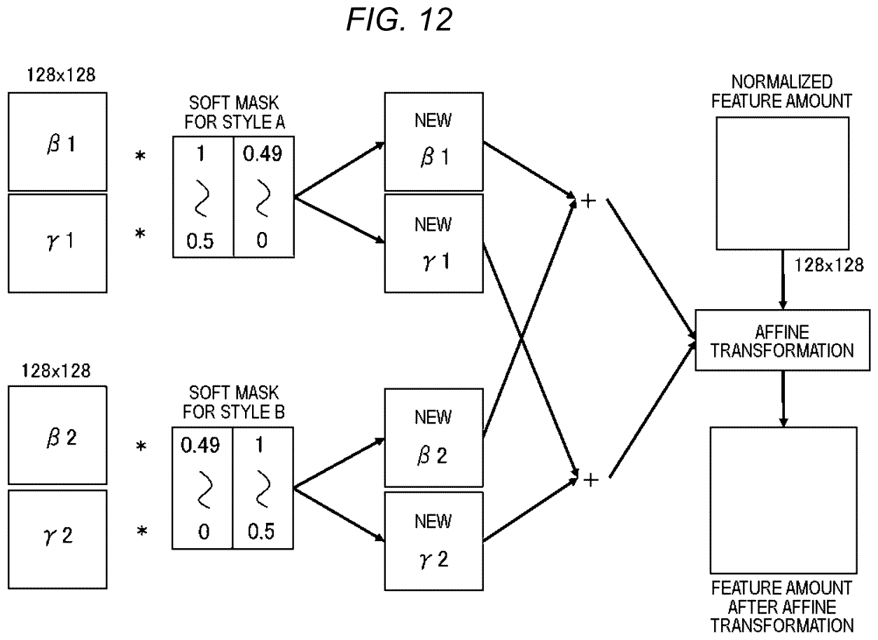

FIG. 12 is a conceptual diagram illustrating an affine transformation process after normalization, according to at least one embodiment of the present disclosure. The affine transformation process illustrated in FIG. 12 corresponds to the Masked Affine Transform described above.

It is assumed that the two types of parameters used in the affine transformation for style A are β1 and γ1, respectively. It is assumed that the two types of parameters used in the affine transformation for style B are β2 and γ2, respectively. β1, β2, γ1, and γ2 in the present example are each data having a size of 128×128.

The style transfer unit 203 applies the style A soft mask to β1 and γ1. As a result, a new β1 and a new γ1 are obtained. The algorithm for applying the style A soft mask may be, for example, multiplication of values in the same row and the same column. In a specific example, the result of multiplying the value in Row 2 and Column 2 of β1 by the value in Row 2 and Column 2 of the style A soft mask becomes the value in Row 2 and Column 2 of the new β1. The same applies to the application of the style A soft mask to γ1.

The style transfer unit 203 applies the style B soft mask to β2 and γ2. As a result, a new β2 and a new γ2 are obtained. The algorithm for applying the style B soft mask may be, for example, multiplication of values in the same Row and the same column. In a specific example, the result of multiplying the value in Row 2 and Column 2 of β2 by the value in Row 2 and Column 2 of the style B soft mask becomes the value in Row 2 and Column 2 of the new β2. The same applies to the application of the style B soft mask to γ2.

The style transfer unit 203 performs affine transformation on the normalized feature amount (see FIG. 11) using the data obtained by adding β1 and β2 and the data obtained by adding γ1 and γ2 as parameters. As a result, affine-transformed feature amounts are extracted from the processing layer.

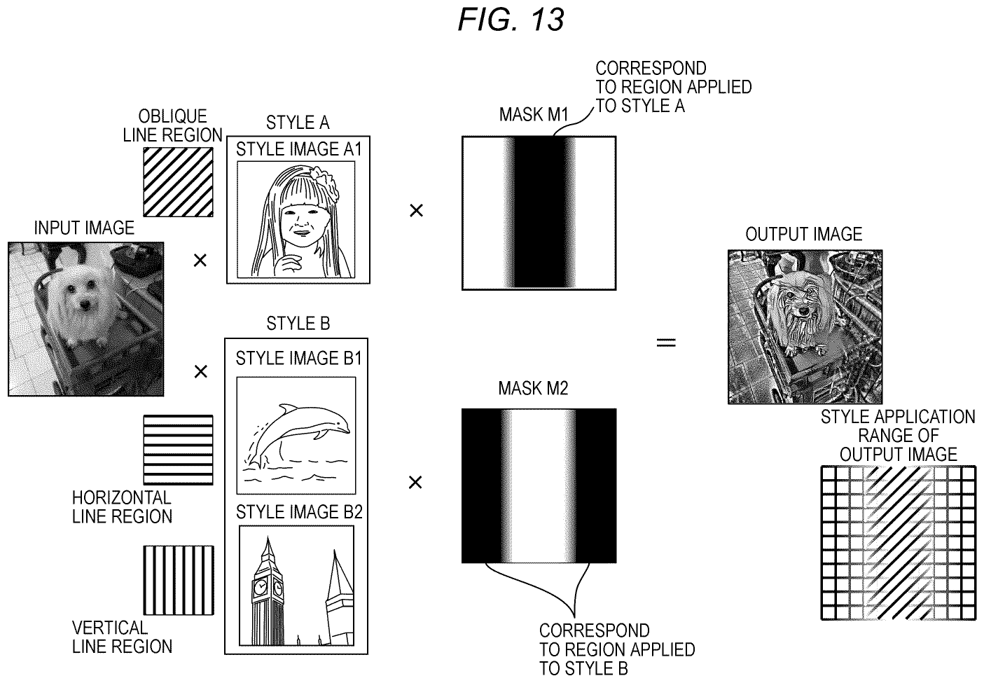

FIG. 13 is a conceptual diagram illustrating a style transfer process using masks, according to at least one embodiment of the present disclosure.

It is assumed that image data in which a dog is reflected is an input image. M1 is a mask that prevents style transfer for a partial region of the image data. The mask M1 is a mask for preventing style transfer for the left edge region and right edge region of the image data. The central region (black) of the mask M1 has a value of 1 or close to 1. The left edge region (white) and the right edge region (white) of the mask M1 have values of 0 or close to 0. Therefore, for example, when the mask M1 is transformed to a hard mask by rounding off, the value of the central region of the hard mask becomes 1, and the value of the left edge region and the right edge region becomes 0.

The style transfer unit 203 also generates a mask M2 by inverting the values of the mask M1. For example, when the value of the pixel at the coordinates (i, j) of the mask M1 is aij and the value of the pixel at the coordinates (i, j) of the mask M2 is bij, the style transfer unit 203 may generate the mask M2 in which the values of the mask M1 are inverted by calculating bij=1−aij. If the mask M1 has values as those of, for example, the style A soft mask illustrated in FIG. 11, the style transfer unit 203 may obtain the mask M2 by swapping the left side region (1 to 0.5) and the right side region (0.49 to 0). That is, the style transfer unit 203 performs inversion processing (horizontal inversion, vertical inversion, 1-aij, and the like) according to the mode of the mask to be inverted. The central region (white) of the mask M2 has a value of 0 or close to 0. The left edge region (black) and the right edge region (black) of the mask M2 have values of 1 or close to 1. Therefore, for example, when the mask M2 is transformed to a hard mask by rounding off, the value of the central region of the hard mask becomes 0, and the value of the left edge region and the right edge region becomes 1.

The style transfer unit 203 applies style transfer based on one or more style images to the image data using masks. In FIG. 13, the style transfer unit 203 uses the masks M1 and M2 to apply style transfer based on style images A1, B1, and B2 to image data including a dog. Style A is a style composed solely of the style image A1. Style B is a style in which the style image B1 and the style image B2 are blended. FIG. 13 conceptually illustrates a style transfer process using a mask. Therefore, the style images A1, B1, and B2 depicted in FIG. 13 are not the style images actually used by the applicant. For convenience of explanation, three rectangles indicating an oblique line region, a horizontal line region, and a vertical line region are described near the respective style images A1, B1, and B2. The three rectangles indicating the oblique line region, the horizontal line region, and the vertical line region, respectively, are described to illustrate where and how the respective style images A1, B1, and B2 are applied to the output image. The mask M1 corresponds to a style A soft mask. The mask M2 corresponds to a style B soft mask.

The output image after the style transfer is applied is an image in which style transfer is performed on the central region to style A and on the left edge region and the right edge region to style B.

The values possessed by the mask M1 and the mask M2 are continuous values between 0 and 1. Therefore, in a partial region of the output image (near the boundary between the central region and the edge region), style A and style B are not simply averaged but are blended nicely by one calculation. In FIG. 13, a rectangle indicating the style application range of the output image is described near the output image. In the vicinity of the boundary between the central region and the edge regions of the output image, the oblique line region (corresponding to style image A1), the horizontal line region (corresponding to style image B1), and the vertical line region (corresponding to style image B2) are mixed. If hard masks were used as the masks M1 and M2, the styles A and B would not be mixed in the output image, and the styles would be divided for each region and style transfer would be performed.

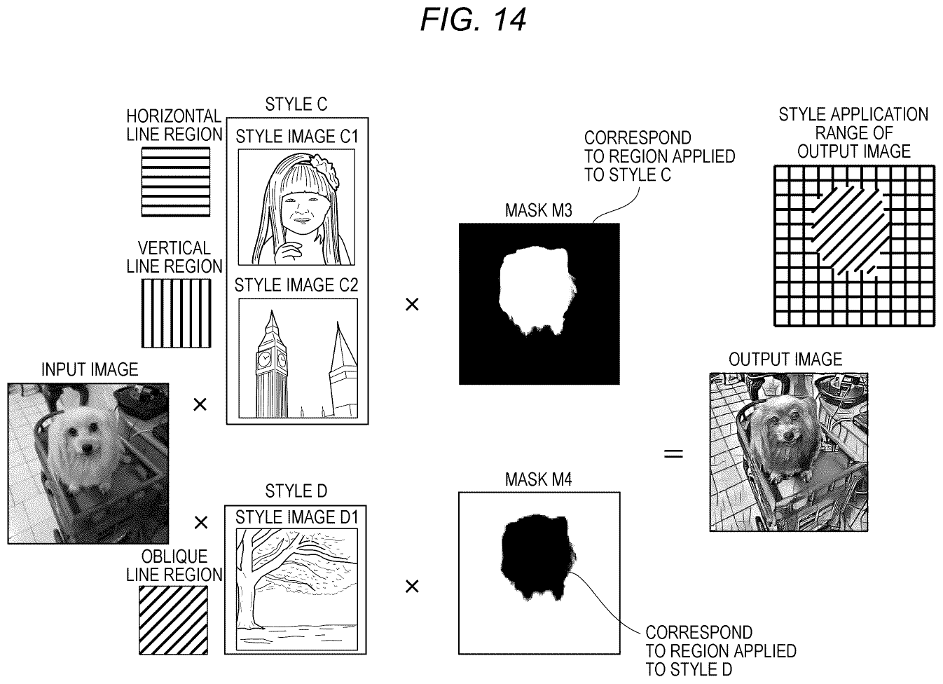

FIG. 14 is a conceptual diagram illustrating a style transfer process using masks, according to at least one embodiment of the present invention.

It is assumed that image data in which a dog is reflected is an input image. The style transfer unit 203 acquires a mask M3 for preventing style transfer for a partial region of the image data. FIG. 14 illustrates a mask M3 for preventing style transfer for a region corresponding to a dog in image data. The value of the region (black) corresponding to the portion other than the dog of the mask M3 is 1. The value of the region (white) corresponding to the dog of the mask M3 is 0.

The style transfer unit 203 also obtains a mask M4 by inverting the values of the mask M3. For example, when the value of the pixel at the coordinates (i, j) of the mask M3 is cij and the value of the pixel at the coordinates (i, j) of the mask M4 is dij, the style transfer unit 203 may generate the mask M4 in which the values of the mask M3 are inverted by calculating dij=1−cij. If the mask M3 has values as those of, for example, the style A hard mask illustrated in FIG. 10, the style transfer unit 203 may obtain the mask M4 by swapping the left side region (the value is 1) and the right side region (the value is 0). The style transfer unit 203 performs inversion processing (horizontal inversion, vertical inversion, 1-cij, and the like) according to the mode of the mask to be inverted. The value of the region (white) corresponding to the portion other than the dog of the mask M4 is 0. The value of the region (black) corresponding to the dog of the mask M4 is 1.

The style transfer unit 203 applies style transfer based on one or more style images to the image data using masks. In FIG. 14, the style transfer unit 203 uses masks M3 and M4 to apply style transfer based on the style images C1, C2, and D1 to image data in which a dog is reflected. Style C is a style in which the style image C1 and the style image C2 are blended. Style D is a style composed solely of the style image D1. FIG. 14 conceptually illustrates a style transfer process using a mask. Therefore, the style images C1, C2, and D1 depicted in FIG. 14 are not the style images actually used by the applicant. For convenience of explanation, three rectangles indicating a horizontal line region, a vertical line region, and an oblique line region are described near the respective style images C1, C2, and D1. The three rectangles indicating the horizontal line region, the vertical line region, and the oblique line region respectively, are described to illustrate where and how the respective style images C1, C2, and D1 are applied to the output image. The mask M3 corresponds to a style C hard mask. The mask M4 corresponds to a style D hard mask.

The output data after the style transfer is applied is an output image in which the region corresponding to the portion other than the dog is style-transferred to style C, and the region corresponding to the dog is style-transferred to style D.

The values possessed by the mask M3 and the mask M4 are 0 or 1. That is, the mask M3 and the mask M4 are hard masks. Therefore, style C and style D are not mixed in the output image, and styles are divided into dog and non-dog regions, and style transfer is performed by one calculation. In FIG. 14, a rectangle indicating the style application range of the output image is described near the output image. An oblique line region (corresponding to the style image D1) is applied to the region corresponding to the dog in the output image. A horizontal line region (corresponding to the style image C1) and a vertical line region (corresponding to the style image C2) are applied to the region corresponding to the portion other than the dog in the output image.

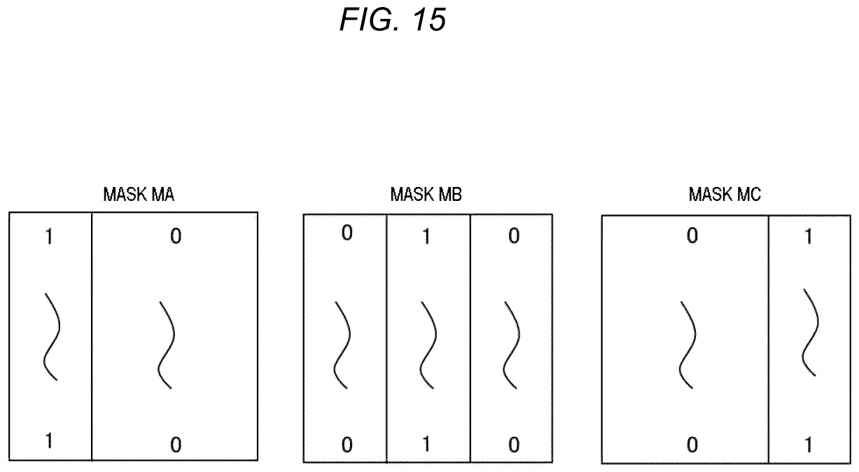

Masks can also be used when it is desired to divide a region of image data into three or more divisions and apply different styles to each division. FIG. 15 is a conceptual diagram illustrating masks when it is desired to divide image data into three regions and apply different styles to each region, according to at least one embodiment of the present disclosure.

Three masks MA, MB, and MC are prepared. For example, the mask MA has a value of 1 in the left third region and a value of 0 in the other region. The mask MB has a value of 1 in the region in the central portion and a value of 0 in the left third region and the right third region. The mask MC has a value of 1 in the right third region and a value of 0 in the other region. However, the left, center, and right divisions may not be strictly trisections. In fact, 128 pixels and 256 pixels are not divisible by 3. It is assumed that the mask MA corresponds to style A, the mask MB to style B, and the mask MC to style C, respectively. Also, style A, style B, and style C are assumed to be styles based on one or more different style images.

As described with reference to FIGS. 9 and 10, the style transfer unit 203 applies a hard mask to the feature amount data after convolution, and then calculates the average and standard deviation. It is assumed that μ1 and σ1 are the average and standard deviation corresponding to the mask MA, respectively. It is assumed that μ2 and σ2 are the average and standard deviation corresponding to the mask MB, respectively. It is assumed that μ3 and σ3 are the average and standard deviation corresponding to the mask MC, respectively.

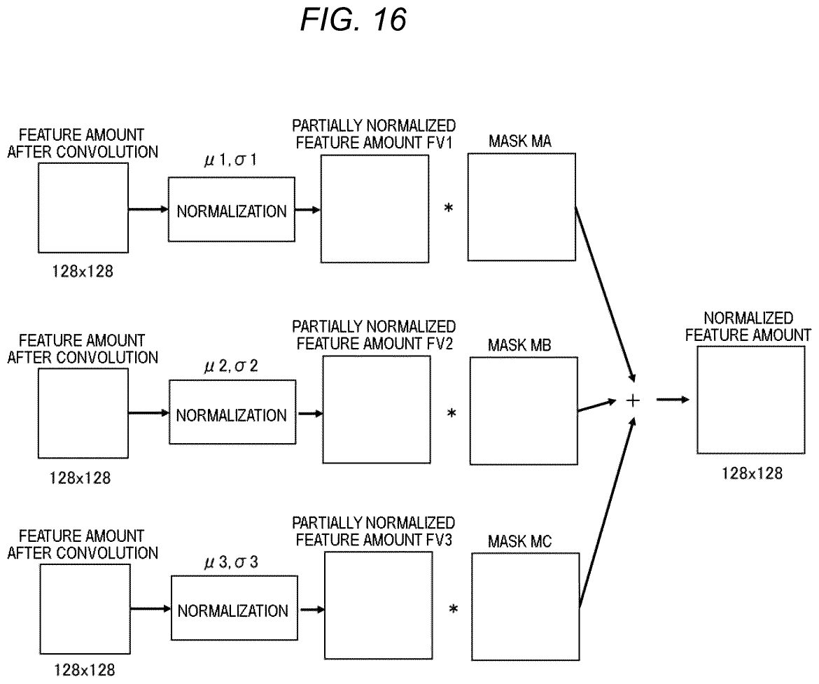

FIG. 16 is a conceptual diagram illustrating normalization performed in the processing layer, according to at least one embodiment of the present disclosure. As described with reference to FIG. 11, the style transfer unit 203 normalizes the feature amount data after convolution using the average μ1 and the standard deviation α1. As a result, a partially normalized feature amount FV1 is obtained. The style transfer unit 203 applies the mask MA to the partially normalized feature amount FV1. A feature amount obtained by applying the mask MA is assumed to be a feature amount FV1A. The algorithm for applying the mask MA to the feature amount FV1 may be, for example, multiplication of values in the same row and the same column. In a specific example, the result of multiplying the value in Row 2 and Column 2 of the feature amount FV1 by the value in Row 2 and Column 2 of the mask MA becomes the value in Row 2 and Column 2 of the feature amount FV1A.

The style transfer unit 203 normalizes the feature amount data after convolution using the average μ2 and the standard deviation σ2. As a result, a partially normalized feature amount FV2 is obtained. The style transfer unit 203 applies the mask MB to the partially normalized feature amount FV2. A feature amount obtained by applying the mask MB is assumed to be a feature amount FV2B. The algorithm for applying the mask MB to the feature amount FV2 may be, for example, multiplication of values in the same row and the same column. In a specific example, the result of multiplying the value in Row 2 and Column 2 of the feature amount FV2 by the value in Row 2 and Column 2 of the mask MB becomes the value in Row 2 and Column 2 of the feature amount FV2B.

The style transfer unit 203 normalizes the feature amount data after convolution using the average μ3 and the standard deviation σ3. As a result, a partially normalized feature amount FV3 is obtained. The style transfer unit 203 applies the mask MC to the partially normalized feature amount FV3. A feature amount obtained by applying the mask MC is assumed to be a feature amount FV3C. The algorithm for applying the mask MC to the feature amount FV3 may be, for example, multiplication of values in the same row and the same column. In a specific example, the result of multiplying the value in Row 2 and Column 2 of the feature amount FV3 by the value in Row 2 and Column 2 of the mask MC becomes the value in Row 2 and Column 2 of the feature amount FV3C.

The style transfer unit 203 adds the feature amount FV1A, the feature amount FV2B, and the feature amount FV3C. As a result, a normalized feature amount of 128 vertical×128 horizontal is obtained. The addition of the feature amount FV1A, the feature amount FV2B, and the feature amount FV3C may be, for example, the addition of the values in the same row and the same column. In a specific example, the result of adding the value in Row 2 and Column 2 of the feature amount FV1A, the value in Row 2 and Column 2 of the feature amount FV2B, and the value in Row 2 and Column 2 of the feature amount FV3C becomes the value in Row 2 and Column 2 of the normalized feature amount.

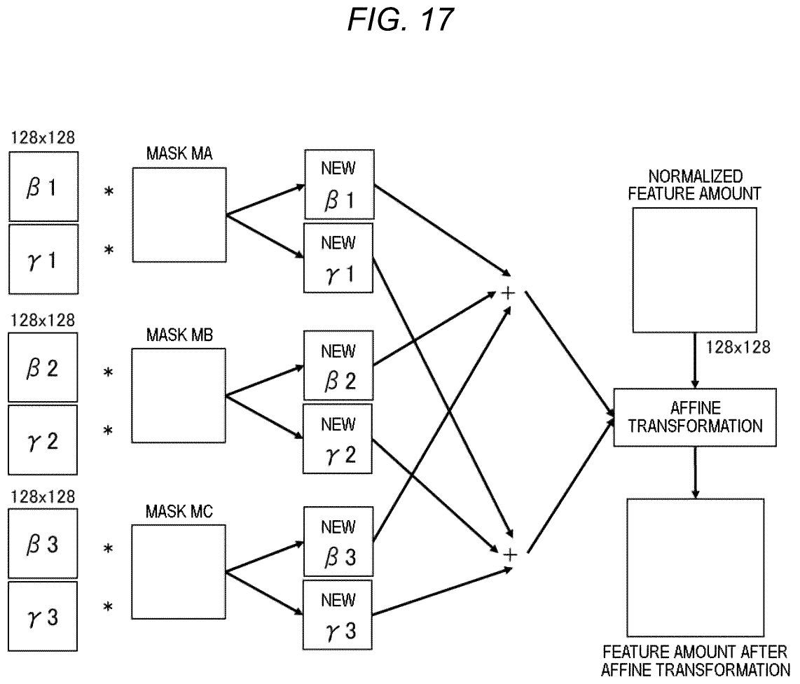

FIG. 17 is a conceptual diagram illustrating an affine transformation process after normalization, according to at least one embodiment of the present disclosure.

It is assumed that the two types of parameters used in the affine transformation for style A are β1 and γ1, respectively. It is assumed that the two types of parameters used in the affine transformation for style B are β2 and γ2, respectively. It is assumed that the two types of parameters used in the affine transformation for style C are β3 and γ3, respectively. β1, β2, β2, γ1, γ2, and γ3 in the present example are each data having a size of 128×128.

The style transfer unit 203 applies the mask MA to β1 and γ1. As a result, a new β1 and a new γ1 are obtained. The style transfer unit 203 applies the mask MB to β2 and γ2. As a result, a new β2 and a new γ2 are obtained. The style transfer unit 203 applies the mask MC to β3 and γ3. As a result, a new β3 and a new γ3 are obtained. The algorithm for applying the masks MA, MB, and MC may be, for example, multiplication of values in the same row and the same column.

The style transfer unit 203 performs affine transformation on the normalized feature amount (see FIG. 16) using the data obtained by adding β1, β2, and β3 and the data obtained by adding γ1, γ2, and γ3 as parameters. As a result, affine-transformed feature amounts are extracted from the processing layer.

The style transfer unit 203, for example, inputs the input image and the masks MA, MB, and MC to the neural network N3 illustrated in FIG. 7. As a result, the trained neural network outputs an output image in which style transfer has been performed based on different styles in each of the three regions of the left end, center, and right end.

### Application Example 1

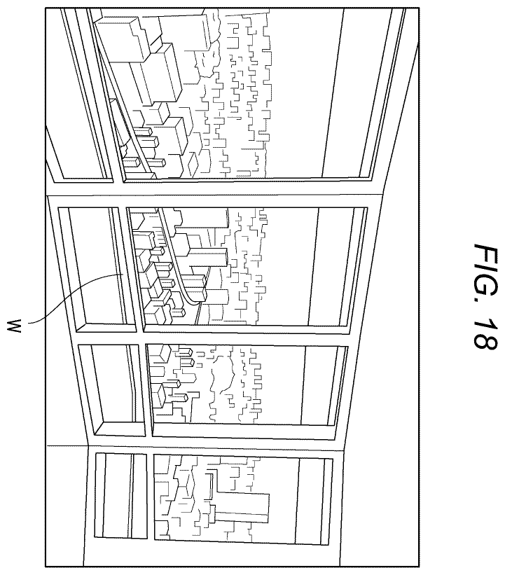

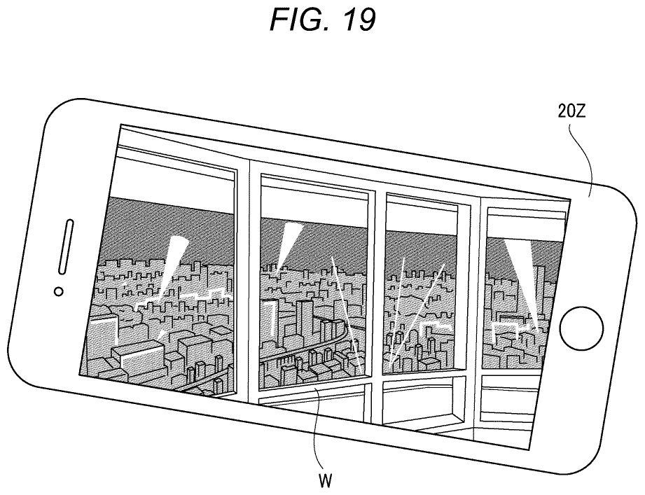

FIG. 18 is a conceptual diagram illustrating an image before style transfer, according to at least one embodiment of the present disclosure. FIG. 19 is a conceptual diagram illustrating a state in which an image after style transfer is output to a user terminal, according to at least one embodiment of the present disclosure.

In the example of FIG. 18, the user is on a high floor of a building. It is assumed that the user operates the user terminal 20Z and captures the scenery outside the window with the camera of the user terminal 20Z. The captured image becomes the application target of the style transfer.

In step St11 in FIG. 3, the distance estimation unit 201 estimates the distance to the target included in the image. The target in this example is a window W installed in a building. That is, the distance estimation unit 201 estimates the distance from the camera of the user terminal 20Z to the window W.

In step St12, the region defining unit 202 demarcates one or more regions from the image based on the estimated distance. The region in this example may be a portion of the image that is a predetermined distance or more away from the window W, that is, a portion of the scenery reflected on the window W.

In step St13, the style transfer unit 203 performs a style transfer on the region in the image. More specifically, the style transfer unit 203 generates a mask corresponding to the shape of the defined region, and uses the generated mask to apply style transfer to the region in the image.

For example, if an image of a townscape that appears in a video game is used as the style image, the scenery seen from the building in the real world will be style-transferred to the townscape style that appeared in the video game, as illustrated in FIG. 19, in the output image after the style transfer is applied. On the other hand, the region corresponding to the portion inside the window W of the building in the output image is not subjected to style transfer and remains as the original image of the real world.

### Application Example 2

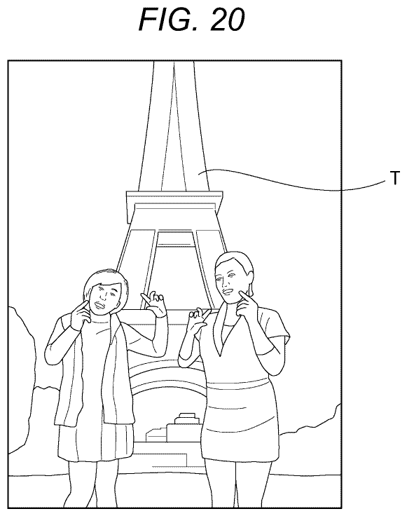

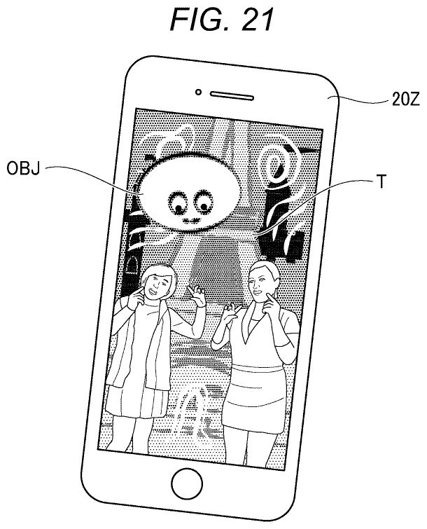

FIG. 20 is a conceptual diagram illustrating an image before style transfer, according to at least one embodiment of the present disclosure. FIG. 21 is a conceptual diagram illustrating a state in which an image after style transfer is output to a user terminal, according to at least one embodiment of the present disclosure.

In the example of FIG. 20, the user is in front of a tower T. The user operates the user terminal 20Z to take an image with the camera of the user terminal 20Z. The captured image becomes the application target of the style transfer.

In step St11 in FIG. 3, the distance estimation unit 201 estimates the distance to the target included in the image. The target in this example is the tower T. That is, the distance estimation unit 201 estimates the distance from the camera of the user terminal 20Z to the tower T.

In step St12, the region defining unit 202 demarcates one or more regions from the image based on the estimated distance. The region in this example may be a portion of the image that is a predetermined distance or more away from the tower T, that is, a portion of the tower T, and a portion of the background when the tower T is the foreground.

In step St13, the style transfer unit 203 performs a style transfer on the region in the image. More specifically, the style transfer unit 203 generates a mask corresponding to the shape of the defined region, and uses the generated mask to apply style transfer to the region in the image.

In the output image after the style transfer is applied, the style of the tower T and the background of the tower T are style-transferred based on the style image, as illustrated in FIG. 21. On the other hand, in the output image, the region corresponding to the front side of the tower T is not subjected to style transfer and remains as the original image of the real world.

Here, as AR output, a virtual object OBJ may be superimposed on an image and output. If the object OBJ is simply superimposed on the image, the output image will reflect the scenery and objects of the real world as a whole, and the virtual object OBJ will be additionally reflected, and thus, there is a possibility of causing a sense of incompatibility to the user.

Therefore, according to the embodiment of the present disclosure, the style transfer unit 203 also performs style transfer on objects superimposed on the image. That is, the style transfer unit 203 performs style transfer on both the above-described regions and objects. By applying style transfer to both the region and the object to align the directionality of expression, the above sense of incompatibility can be alleviated.

The one or more style images used for style transfer to an object may be images corresponding to the one or more style images used for style transfer to a region.

For example, when there are a style image A and a style image B, the fact that the style image B corresponds to the style image A means that the two have the following relationship, for example.

Style image A and style image B are the same image.

Style image A and style image B are similar.

The style of style image A and the style of style image B are the same.

The style of style image A and the style of style image B are similar.

FIG. 22 is a flowchart illustrating a processing example of a style transfer program according to at least one embodiment of the present disclosure.

The distance estimation unit 201 estimates the distance to a target included in an image (St31). The image composite unit 206 blends the object OBJ with the image to obtain a composite image (St32). The region defining unit 202 demarcates one or more regions from the composite image based on the estimated distance (St33). The style transfer unit 203 performs a style transfer on the region in the composite image (St34).

In step St34, mask style transfer is used as the type of style transfer. By using mask style transfer, it is possible to apply style transfer only to a partial region of an image, for example, without dividing the image by appropriately setting mask values. Therefore, even after the virtual object OBJ, which is the target of AR output, is blended with the image, desired style transfer can be performed on the composite image.

As one aspect of the embodiment of the present disclosure, a highly expressive image can be output.

As one aspect of the embodiment of the present disclosure, the model can be used to accurately estimate the distance to a target.

As one aspect of the embodiment of the present disclosure, mask style transfer allows different style transfer for different regions.

As one aspect of the embodiment of the present disclosure, when a virtual object is superimposed on an image, a sense of incompatibility can be reduced by applying style transfer to both the region and the object to align the directionality of expression.

As described above, the embodiments of the present application address one or more problems. In addition, the effect by each embodiment is a non-limiting effect or an example of effects.

In each of the above-described embodiments, the user terminal 20 and the server 10 execute the above-described various processes according to various control programs (for example, style transfer programs) stored in their own storage devices. Further, another computer, not limited to the user terminal 20 or the server 10, may execute the various processes described above in accordance with various control programs (for example, a style transfer program) stored in its own storage device.

Also, the configuration of the image processing system 100 is not limited to the configuration described as an example of the above embodiment. For example, the server 10 may be configured to execute part or all of the processes described as being executed by the user terminal 20, or the user terminal 20 may be configured to execute some or all of the processes described as being executed by the server 10. Further, the user terminal 20 may be configured to include part or all of the storage unit (storage device) included in the server 10. That is, in the image processing system 100, either one of the user terminal and the server may be configured to provide a part or all of the functions of the other.

Also, the program may be configured to implement part or all of the functions described as examples of the above-described embodiments in a single device that does not include a communication network.

[Note]

The above description of embodiments describes at least the following disclosure in such a way that a person ordinary skilled in the art of the disclosure can practice the disclosure.
[1]

A style transfer program causing a processor to implement
a distance estimation function of estimating a distance to a target included in an image,
a region defining function of demarcating one or more regions from the image based on the estimated distance, and
a style transfer function of performing style transfer to the regions in the image.
[2]

The style transfer program according to [1] causing a processor to further implement
a model identification function of identifying a model corresponding to the target; in which
in the distance estimation function, the distance to the target is estimated based on the identified model.
[3]

The style transfer program according to [1], in which
in the style transfer function, the style transfer is performed using a mask corresponding to the shape of the region in the image.
[4]

The style transfer program according to any one of [1] to [3], in which
in the style transfer function, the style transfer is performed for objects superimposed on the image.
[5]

A style transfer device including:
a processor and a memory, in which
the processor cooperates with the memory to implement
a distance estimation function of estimating a distance to a target included in an image,
a region defining function of demarcating one or more regions from the image based on the estimated distance, and
a style transfer function of performing a style transfer to the regions in the image.
[6]

A style transfer method by a computer device equipped with a processor and a memory, the method including:
a distance estimation process of estimating a distance to a target included in an image,
a region defining process of demarcating one or more regions from the image based on the estimated distances, and
a style transfer process of performing a style transfer to the regions in the image.

According to one embodiment of the present disclosure, it is useful as a style transfer program, a style transfer device, and a style transfer method capable of outputting a highly expressive image based on an input image.

What is claimed is:

1. A non-transitory computer-readable medium storing a style transfer program including instructions which, when executed, cause a processor to perform operations comprising:
estimating a distance to a target included in an image;
demarcating one or more regions from the image based on the estimated distance; and
performing style transfer to the regions in the image.

2. The non-transitory computer-readable medium according to claim 1, wherein the operations further comprise identifying a model corresponding to the target,
wherein the distance to the target is estimated based on the identified model.

3. The non-transitory computer-readable medium according to claim 1, wherein the style transfer is performed using a mask corresponding to a shape of the region in the image.

4. The non-transitory computer-readable medium according to claim 1, wherein the style transfer is performed for objects superimposed on the image.

5. A style transfer device comprising:
a processor; and
a non-transitory computer readable medium storing computer-executable instructions which, when executed, cause the processor to perform operations comprising:
estimating a distance to a target included in an image;
demarcating one or more regions from the image based on the estimated distance; and
performing a style transfer to the regions in the image.

6. A style transfer method comprising:
estimating a distance to a target in an image by a computing device;
demarcating one or more regions from the image based on the estimated distances by the computing device, and
performing a style transfer to the regions in the image by the computing device.
